(19) United States
(12) Patent Application Publication
(10) Pub. No.: US 2004/0234644 A1
(43) Pub. Date: Nov. 25, 2004

(54) Heat dispensing device for runners of molds

(76) Inventor: Chin-Yung Peng, Chang-Hua City (TW)

Correspondence Address: CHIN-YUNG PENG, P.O. BOX 487, Chang-Hua City 500, TW

(21) Appl. No.: 10/440,236

(22) Filed: May 19, 2003

(51) Int. Cl. B29C 45/22

(52) U.S. Cl. 425/543

(57) ABSTRACT

A molding machine includes an upper board connected to a material injection device and a runner base is connected to an underside of the upper board. The runner base includes a heat-isolating board and a scrap removal board connected to the heat-isolating board. A plurality of runners are defined through the heat-isolating board and communicate with an entrance on the upper board so that material enters from the entrance into the runners. A lower board is connected to a hydraulic device and a mold assembly with concavities is connected to a top of the lower board. The heat is removed by the heat isolating board so that the material is not over-heated and can be reused.

### FIELD OF THE INVENTION

The present invention relates to rubber or silicon injection molding machine, and more particularly, to a heat dispensing device located between the molds and the injection machine so, as to remove heat from the material in the runners.

### BACKGROUND OF THE INVENTION

A conventional rubber molding machine 90 is disclosed in FIG. 5 and generally includes an upper board 91 movably connected to four posts (only two are illustrated) and a material injection device is connected to the upper board 91. A lower board 92 which is movably connected to the posts and a hydraulic device is used to raise the lower board toward the upper board 91. Each of the upper board 91 and the lower board 92 has a mold 93 which has a concavity 931 defined therein. A runner 94 is defined in the upper board 91 and communicates with the concavity 931 in the mold 93 on the upper board 91 and the two concavities 931 are in communication with each other when the two molds 93 are matched with each other. In order to let the rubber material that is to be poured into the concavities 931 in a workable status, a heater which is not shown in the drawing is located between the upper board 91 and the lower board 92 at 120 to 180 degrees Celsius. Nevertheless, the heat also affects the paths communicating with the concavities 931 of the molds 93 so that the rubber in these paths are also be heated and becomes scraps which cannot be recycled or reused.

The present invention, intends to provide a heat dispensing device that removes heat from the material in the runners before the material entering the concavities in the molds.

### SUMMARY OF THE INVENTION

In accordance with one aspect of the present invention, there is provided a molding machine which comprises an upper board connected to a material injection device and a runner base is connected to an underside of the upper board. An entrance is defined in the upper board and the runner base includes a heat-isolating board and a scrap removal board. A plurality of runners are defined through the heat-isolating board and the entrance communicates with the runners. A lower board is connected to a hydraulic device and a mold assembly with concavities is connected to a top of the lower board. The concavities communicate with the runners. The heat is removed from the heat isolating board to prevent the material in the runners from being overheated.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the molding machine of the present invention;

FIG. 2 is a cross sectional view to show the runner base and the mold assembly of the molding machine of the present invention,

FIG. 3 shows, another embodiment of the runner base and the mold assembly of the molding machine of the present invention;

FIG. 4 is a perspective view to show a heat dispensing board used in the embodiment shown in FIG. 3, and

FIG. 5 shows a conventional first conventional rubber molding machine.

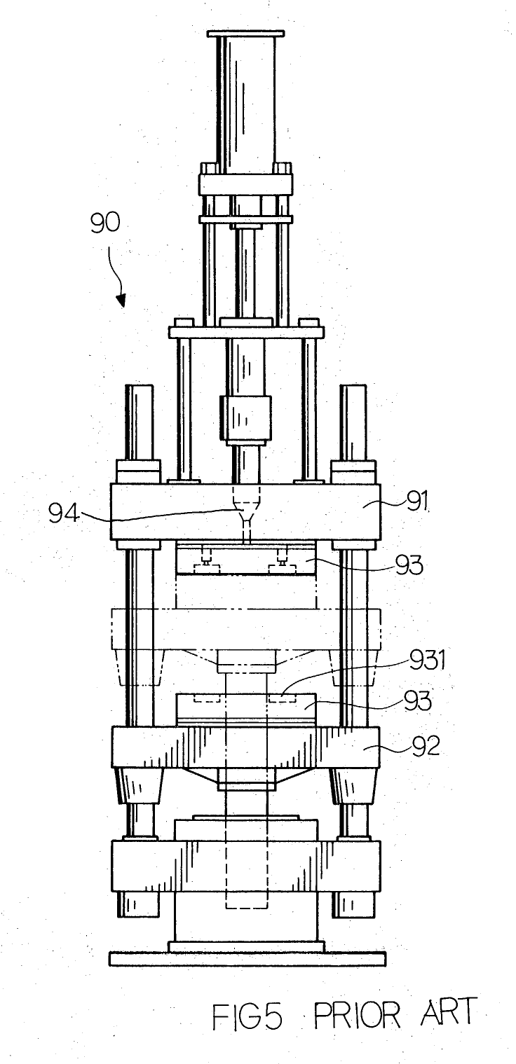

### DETAILED DESCRIPTION OF THE PREFERRED EMBODIMENT

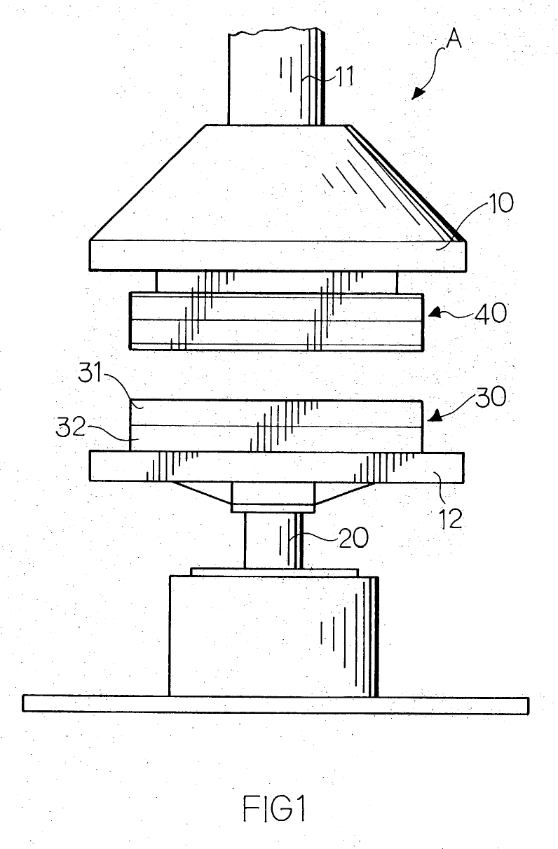

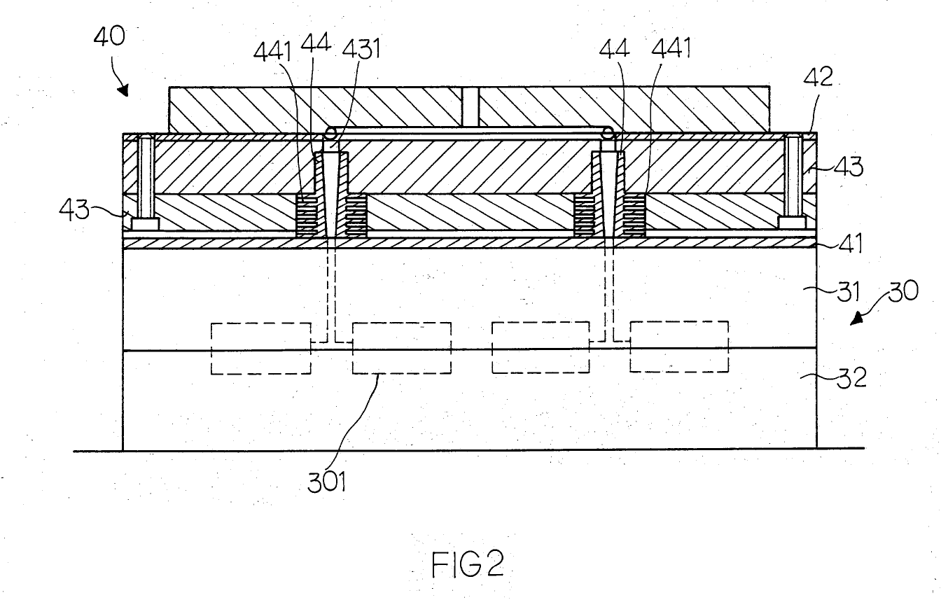

Referring to FIGS. 1 and 2, the molding machine “A” of the present invention comprises an upper board 10 connected to a material injection device 11 and an entrance 111 is defined in the upper board 10 so that material such as rubber or silicon is sent by the material injection device 11 into a mold assembly 30 which will be illustrated hereinafter via the entrance 111. A runner base 40 is connected to an underside of the upper board 10 and includes two asbestos made heat-isolating boards 43, a dispensing board 42 connected to a top of the heat isolating boards 43, and a scrap removal board 41 connected to an underside of the heat-isolating boards 43. A plurality of runners 431 are defined through the heat-isolating board 43 and a plurality of paths are defined in the dispensing board 42 so as to be in communication between the entrance 11 and the runners 431.

Each runner 431, is enclosed by a runner casing 44 and a heat dispensing device 441 such as a plurality of heat dispensing fins, is connected to each runner casing 44. The runner casings 44 can be a close-end casing or an open end casing. By setting the runner casings 44 at desired positions so that the material is guided to enter into the mold assembly 30 from desired positions.

A lower board 12 is connected to a hydraulic device 20 and the mold assembly 30 is connected to a top of the lower board 12 so that the mold assembly 30 can be raised by the hydraulic device 20 and is matched with the runner base 40. The mold assembly 30 includes an upper mold 31 and a lower mold 32 and each of which has a concavity 301 which communicates with the runners 431. The material is then filled into the concavities 301 in the mold assembly 30 via the runners 431 to form a product. The heat isolating boards 43 prevent the heat coming from the upper board 10 from being transferring to the mold assembly 30. The heat dispensing device 441 further dispenses heat from the material in the runners 431 so that when removing the scrap removal board 41 after the molding process is finished, the material in the runners 431 is still re-usable.

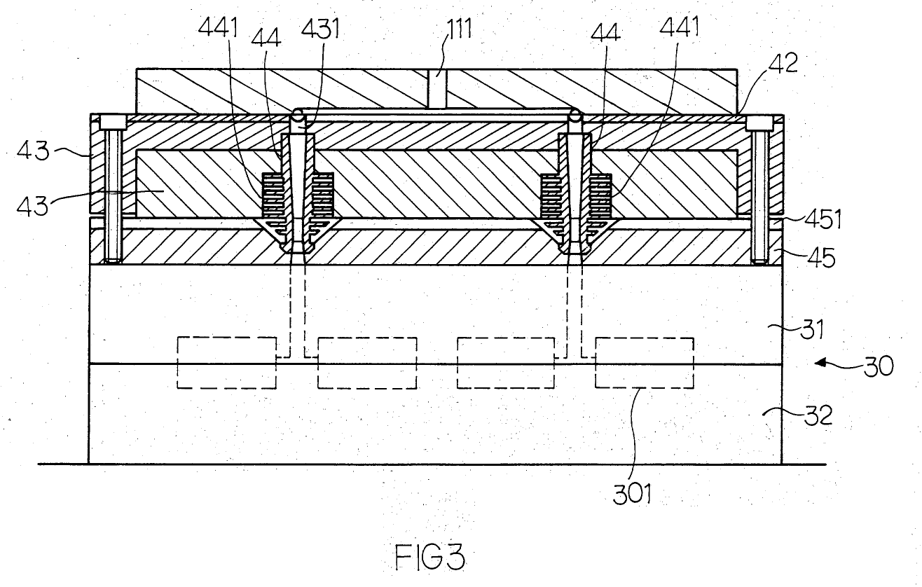

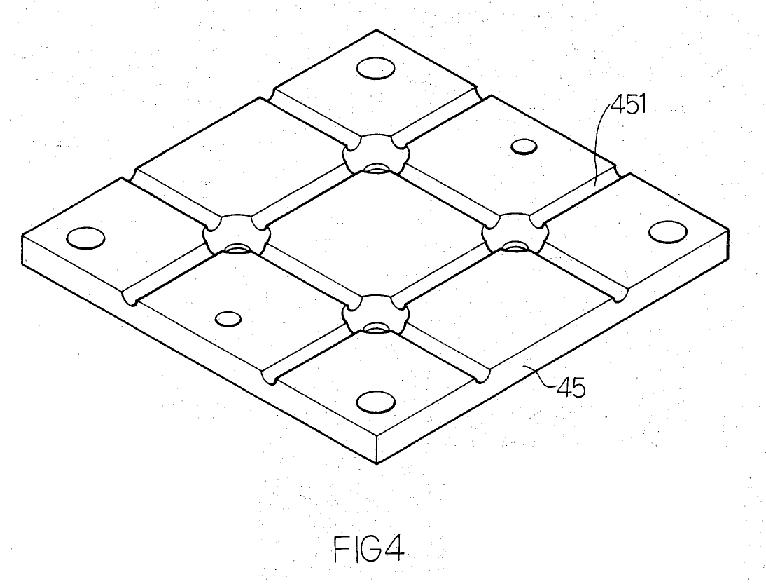

Referring to FIGS. 3 and 4, in another embodiment of the heat dispensing device, a heat dispensing board 45 is connected to an underside of the heat isolating boards 43 and includes a plurality of holes communicating with the runners 431. A plurality of heat escaping paths 451 are defined in a surface of the heat dispensing board 45 and in communication with the holes through the heat dispensing board 45. By this way, heat can be taken away from the runners 431. Each runner casing 44 has an enlarged end and the heat dispensing device 441 such as heat dispensing fins, is connected to the enlarged end. The heat dispensing fins have large areas so that the heat is removed efficiently.

While we have shown and described the embodiment in accordance with the present invention, it should be clear to those skilled in the art that further embodiments may be made without departing from the scope of the present invention.

What is claimed is:

1. A molding machine comprising:
an upper board connected to a material injection device and a runner base connected to an underside of the upper board, an entrance defined in the upper board, the runner base including a heat-isolating board and a scrap removal board connected to the heat-isolating board, a plurality of runners defined through the heat-isolating board and the entrance communicating with the runners, and
a lower board connected to a hydraulic device and a mold assembly connected to a top of the lower board, the mold assembly having concavities which communicate with the runners.

2. The molding machine as claimed in claim 1, wherein a dispensing board is connected between the upper board and the runner base, a plurality of paths defined in the dispensing board so as to be in communication between the entrance and the runners.

3. The molding machine, as claimed in claim 1, wherein the heat isolating board is made of asbestos.

4. The molding machine as claimed in claim 1, wherein each runner is connected to a runner casing.

5. The molding machine as claimed in claim 4, wherein a heat dispensing device is connected to each runner casing.

6. The molding machine as claimed in claim 5, wherein each runner casing has an enlarged end and the heat dispensing device is connected to the enlarged end.

7. The molding machine as claimed in claim 1 further comprising a heat dispensing board connected to an underside of the heat isolating board and including a plurality of holes communicating with the runners, a plurality of heat escaping paths defined in a surface of the heat dispensing board and in communication with the holes through the heat dispensing board.
